(19) United States
(12) Patent Application Publication
(10) Pub. No.: US 2024/0268353 A1
(43) Pub. Date: Aug. 15, 2024

(54) ELECTRONIC MONITORING SYSTEMS AND METHODS

(71) Applicant: Robert Young, Waukesha, WI (US)

(72) Inventor: Robert Young, Waukesha, WI (US)

(21) Appl. No.: 18/439,704

(22) Filed: Feb. 12, 2024

Related U.S. Application Data
(60) Provisional application No. 63/445,256, filed on Feb. 13, 2023.

(51) Int. Cl. A01K 29/00; A01K 27/00

(52) U.S. Cl. CPC A01K 29/005; A01K 27/001; A01K 27/009

(57) ABSTRACT

In one embodiment, an animal monitoring system is described. The animal monitoring system may comprise a monitor unit attached to an animal collar. The monitor unit may comprise one or more sensors for detecting health and activity information regarding an animal. The monitor unit may be configured to wirelessly transmit health and activity information relating to the animal via a wireless network to an internet server that is accessible via a remote device. The remote device may comprise a computer, cell phone, laptop, etc. The health and activity information may include information such as the animal's heart rate, respiratory rate, activity level, temperature, blood oxygen levels, electrocardiogram, blood glucose, step count, calories burned, sleep patterns, and location. In one embodiment, the animal monitoring system further comprises a radar-based sensor system configured to use radar to detect health and activity information about the animal.

### CROSS-REFERENCE TO RELATED APPLICATION

The present application claims the benefit of priority from U.S. Provisional Application No. 63/445,256, filed on Feb. 13, 2023, which is hereby incorporated by reference.

### SUMMARY

The present invention relates, in general, to systems and methods for monitoring animals. More particularly, the present invention relates to an animal collar comprising sensors capable of detecting health and activity information relating to at least one of an animal's heart rate, respiratory rate, activity level, temperature, blood oxygen levels, electrocardiogram, blood glucose, step count, calories burned, sleep patterns, and location. The collar is further capable of recording and wirelessly communicating such health and activity information to a server. Electronic devices, such as computers and smart phones, can access the health and activity information from the server via websites, applications, or other software. The system for monitoring animals may further comprise a radar-based monitoring unit for detecting health and activity information of an animal and communicating such information to the animal collar and/or to the server.

### BACKGROUND

Previous devices and methods for monitoring health and activity information of an animal have been bulky, movement limiting, inaccurate, contact-based, and limited to a single or very few measurements. There remains a need for a system and method for monitoring health and activity information of an animal which resolves these issues.

### BRIEF DESCRIPTION OF DRAWINGS

FIG. 1 illustrates a monitoring system in accordance with various embodiments;

FIG. 2 is a schematic diagram of a monitoring system in accordance with various embodiments;

FIG. 3 is a schematic diagram of a monitoring system in communication with various external systems in accordance with various embodiments;

FIG. 4 is a schematic diagram of a networked monitoring system for capturing, recording and transmitting health and activity information to an end user in relation to an animal in accordance with various embodiments; and,

FIG. 5. Illustrates an electronic device for displaying health and activity information relating to an animal in accordance with various embodiments.

The elements in the figures are illustrated for simplicity and clarity and have not necessarily been drawn to scale. Some elements in the figures may be exaggerated or minimized relative to other elements in order to help improve the understanding of the embodiments described herein.

As used herein, the term ‘and/or’ includes any and all combinations of one or more of the associated listed items. In addition, the terminology used herein is for the purpose of describing particular embodiments only and is not intended to be limiting of the disclosure. For example, as used herein, the singular forms of elements are intended to include the plural forms of those elements as well, unless the context clearly indicates otherwise. It will be further understood that the terms ‘comprise,’ ‘comprises,’ ‘comprising,’ ‘include,’ ‘includes,’ and/or ‘including,’ when used in this specification and claims, are intended to specify a non-exclusive inclusion of stated features, numbers, steps, acts, operations, values, elements, and/or components, and do not preclude the presence or addition of one or more other features, numbers, steps, acts, operations, values, elements, components, and/or groups thereof.

It will also be understood that, although the terms ‘first,’ ‘second,’ etc. may be used herein to describe various signals, data, components, and/or elements, these signals, data, components, and/or elements should not be limited by these terms. These terms can simply be used to distinguish one signal, datum, component, and/or element from another. Thus, for example, a first signal, first piece of information, and/or a first element discussed below could be termed a second signal, second piece of information, and/or a second element without departing from the teachings of the present disclosure.

Reference to ‘one embodiment’ or ‘an embodiment’ means that a particular feature, structure, or characteristic described in connection with the embodiment is included in at least one embodiment of the present disclosure. Thus, appearances of the phrases “in one embodiment” or “in an embodiment” in various places throughout this specification are not necessarily all referring to the same embodiment, but in some cases they may.

The use of words ‘about,’ ‘approximately,’ ‘generally,’ or ‘substantially’ means a value of an element is expected to be close to a stated value or position. However, as is well known in the art there are always minor variances preventing values or positions from being exactly stated. At a minimum, values within +/−10% of a stated value can be considered ‘about,’ ‘approximately,’ ‘generally,’ or ‘substantially’ equal to a stated value.

It is further understood that the embodiments illustrated and described hereinafter suitably may be practiced in connection with elements that are not specifically disclosed herein. Furthermore, it is understood that embodiments illustrated and described herein also include variations wherein one or more of the illustrated or described elements may be omitted.

The inventor is fully informed of the standards and application of the provisions of 35 U.S.C. § 112(f). Thus, the use of the words ‘function,’ ‘means’ or ‘step’ in the Detailed Description or Claims is not intended to somehow indicate a desire to invoke the provisions of 35 U.S.C. § 112(f) to define the invention. To the contrary, if the provisions of 35 U.S.C. § 112(f) are sought to be invoked to define the inventions, the claims will specifically and expressly state the exact phrases ‘means for’ or ‘step for’ and the specific function, without also reciting in such phrases any structure, material or act in support of the function. Thus, even when the claims recite a ‘means for . . . ’ or ‘step for . . . ’ if the claims also recite any structure, material, or acts in support of that means or step, or that perform the recited function, then it is the clear intention of the inventor not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the illustrated embodiments, but in addition, include any and all structures, materials, or acts that perform the claimed function as described in alternative embodiments or forms of the invention, or that are well known present or later-developed, equivalent structures, material, or acts for performing the claimed function.

In the following description, and for the purposes of explanation, numerous, specific details are set forth in order to provide a thorough understanding of the various aspects of the invention. It will be understood, however, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software, hardware or a combination of both. It should be noted that there are many different and alternative configurations, devices, and technologies to which the disclosed inventions may be applied. Thus, the full scope of the invention is not limited only to the examples that are described herein.

### DETAILED DESCRIPTION

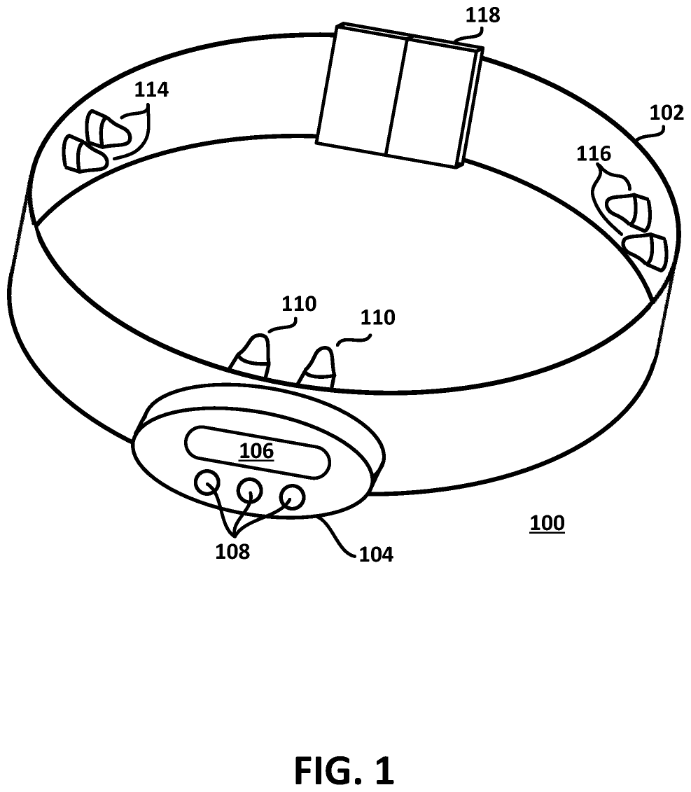

FIG. 1 illustrates a monitoring system or collar 100. Monitoring collar 100 may comprise a collar material or collar strap 102 and a monitor unit 104 mounted, connected, or affixed to collar strap 102. Monitor unit 104 may comprise an integrated electronic information display 106, a user interface 108, and sensor elements 110, 114, and 116, and a fastener 118.

Collar strap 102 may be made of any durable and flexible material suitable for an animal collar. Non-limiting examples of collar strap 102 materials include, leather, metal, metal links, nylon, rope, rubber, or polymer-based materials. The length of collar strap 102 may be adjustable according to the size of the animal and the desired fit. Size adjustments can be made to ensure proper proximity of sensors to the animal. Collar strap 102 may further comprise a metal loop or loops for facilitating the connection of a leash or ID tag(s) to collar strap 102. In some implementations, collar strap 102 may have conductive wires embedded within collar strap 102 in order to facilitate electronic connections between sensors and monitor unit 104. Collar strap 102 can be placed and/or removed from the animal via fastener 118. Fastener 118 may comprise any type of fastener suitable for an animal collar. According to various embodiments, fastener 118 may comprise a buckle, clip, loop and strap, snaps, etc.

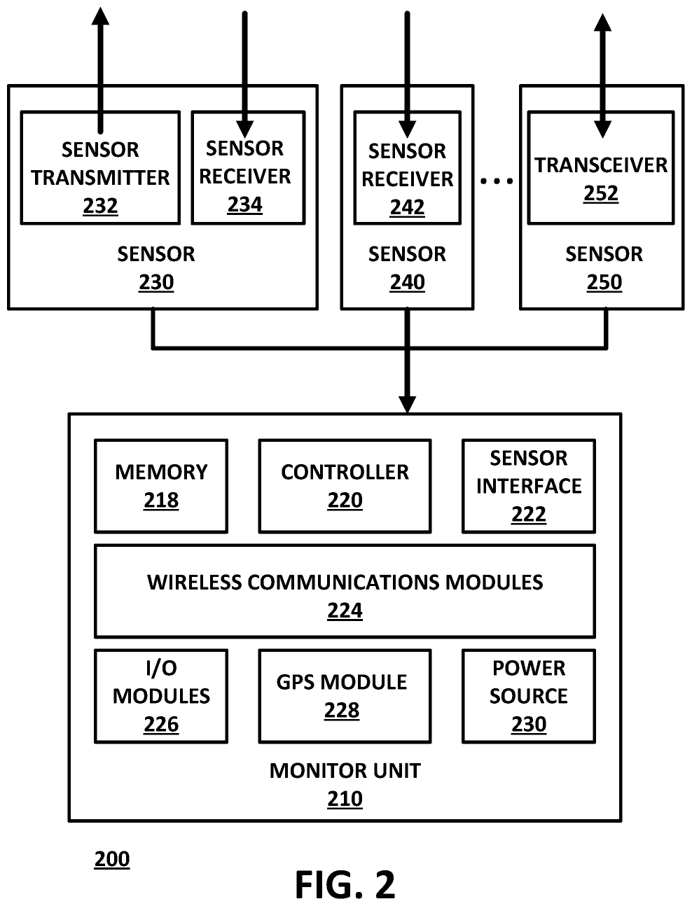

Monitor unit 104, described further in FIG. 2, is configured to obtain, record, and communicate health and activity information relating to at least one of an animal's heart rate, respiratory rate, activity level, temperature, blood oxygen levels, electrocardiogram, blood glucose, step count, calories burned, sleep patterns, and location. Monitor unit 104 may receive such health and activity information, or related information, from sensors 110, 114, and 116. Sensors 110, 114, and 116 may comprise various types of sensors. Non-limiting examples of sensors include electrocardiogram (EKG/ECG) sensors, temperature sensors, blood glucose sensors, pressure sensors, accelerometers, gyroscopes, acoustic sensors (ultrasonic or microphone), respiration sensors, cameras, thermal imaging, blood pressure sensors, optical sensors, heart rate sensors, respiratory rate, oxygenation sensors, oxygen saturation sensors, and pulse oximetry (Sp02) sensors.

In one example, one or more of sensors 110, 114, and 116 may include a core body temperature sensor for monitoring an animal's health and/or activity status. The body temperature sensor can be non-invasive and provide continuous monitoring of the animal's core body temperature. The body temperature sensor may operate based on thermal energy transfer and monitor core body temperature independent of physical activity level or external environmental conditions.

Sensors 110, 114, and 116 are configured to communicate the data/information obtained (sensed) to the monitor unit 104. Sensors 110, 114, and 116 may comprise transmitters, receivers, sources, detectors, probes, electrodes, dome contacts, transducers, MEMs devices, implanted devices, etc. Sensing can be conducted by the sensors directly or indirectly (i.e., inferred). In one embodiment, sensors 110, 114, and 116 may further include an implanted device (such as a pacemaker, RFID chip, microchip, implanted temperature sensor, or glucose sensor) that can be powered and/or queried wirelessly by a transceiver such as sensors 110, 114, and 116.

In one example including an implantable device, an animal may have an implantable device injected beneath the surface of the animal's skin. The implantable device may include an RFID chip or tag which may contain a unique ID code used to distinguish and identify the animal. The implantable device may also include a temperature sensor. One or more of sensors 110, 114, 116, or monitor unit 104, may include an RFID scanner or RFID reader configured to obtain the identification and/or temperature information from the implantable device.

In some implementations, monitor unit 104 may also receive health and activity information from a separate unit, such as a GPS satellite, camera unit, or a radar-based monitoring unit, etc. In various embodiments, monitor unit 104 may comprise a display 106 and a user interface 108. Display 106 can facilitate communication of health and activity information to a user, as well as information relating to settings, parameters, configuration, errors, and status of monitor 104 itself. For example, display 106 may be configured to provide information related to the battery status of monitor unit 104. In various embodiments, user interface 108 can be used to toggle between various data/information displayed on display 106. In some embodiments, user interface 108 can be used to set-up, configure, and/or adjust the settings of monitor unit 104. Monitor unit 104 is coupled to collar strap 102. In some embodiments, monitor unit 104, or a portion of monitor unit 104, is detachable from collar strap 102 to facilitate battery charging of monitor unit 104 without removing collar strap 102 from the animal.

FIG. 2 illustrates a monitoring system 200. Monitoring system 200 is configured to obtain, record, and communicate health and activity information relating to at least one of an animal's heart rate, respiratory rate, activity level, temperature, blood oxygen levels, electrocardiogram, blood glucose, step count, calories burned, sleep patterns, and location. Monitoring system 200 may comprise a monitor unit 210 and one or more sensors such as sensors 230, 240, and 250. Monitor unit 210 may comprise one or more of a memory 218, a controller 220, a sensor interface 222, wireless communications modules 224, I/O modules 226, a GPS module 228, and a power source 230.

Memory 218 may include various memory elements where information, instructions and data may be stored. Memory 218 may store executable instructions for programs for carrying out any of the methods or functions described herein. The memory 218 may also store configurations, settings, sensor data, analysis, or any other information needed for monitor unit to operate according to the descriptions herein. Memory 218 may include one or more of RAM, DRAM, EEPROM, flash memory, solid state storage, etc.

Controller 220 is configured to provide general control of monitor unit 210 and of the elements within monitor unit 210. Controller may be configured to execute various methods and functions as described herein, in conjunction with the other elements of the system. For example, controller 220 can be configured to receive the signal data generated by the sensors, analyze the data and determine a parameter or datum relating to the health and activity information of the animal. Controller 106 may control elements of the monitoring system. For example, controller 220 may trigger sensor 230 to transmit a signal via sensor transmitter 232. Moreover, controller 106 may receive information gathered, detected, sensed by sensor receiver 234.

Generally, controller 220 may be configured to execute instructions to carry out the control of the elements of the monitoring system 200, including the acquisition, retrieval, storage, processing, analysis, generation, reporting, and transmission of data relating to the health and activity of the animal. Controller 220 may control any number of sensors connected to monitor unit 220. Controller 220 may be a microcontroller, CPU, GPU, microprocessor, ASIC, or any type of processor capable of being configured according to the description herein.

In some embodiments, controller 220 is configured to analyze signals and data generated by one or more sensors in order to identify vital signs, health and activity information, signatures, activity, patterns, and conditions of the animal being monitored. In some embodiments, controller 220 can compare current (or recent) data with historical data stored on memory 218 and identify abnormalities, aberrations, and irregularities associated with the animals health and activity information. In yet additional embodiments, controller 220 may be configured to use the information stored on memory to make predictions as to the animal's present or future health and activity information.

The controller may employ machine learning, artificial intelligence (hereinafter “AI”), deep learning, or other models and algorithms to analyze vital signs, location, sleep patterns, activity levels and other data to identify changes and trends that suggest impending health issues. Nonlimiting examples of health issues include pain, sepsis, or a cardiac episode. Monitoring system 200 can be configured to generate and communicate alerts based on the results of the health and activity analysis. Alerts may include alerts such as health alerts, location alerts, and/or activity alerts. In some embodiments, the analysis is conducted on-device, while in other embodiments the analysis is conducted off-device (e.g., on a cloud-based server with access to the health and activity information). Alerts can be transmitted to, or accessed by, individuals associated with the animal (e.g., the animal's owner, caretaker, or veterinarian).

Sensor interface 222 provides an interface for the direct-wired, or wireless, connection of monitor unit 210 to sensors 230, 240, 250, or any other number of sensors configured to operate with monitor unit 210. Sensor interface 222 can transmit and/or receive information, power, signals, and/or data to/from the monitor unit via electrical connections, wires, parallel buses, serial buses, I2C, USB, etc. In some examples, sensor interface 222 can operate in connection with wireless communications modules 224 in order to transmit/receive information to/from sensors via radio frequency (e.g., Wi-Fi, Bluetooth, cellular, etc.) and/or audio/optical transmission.

Sensors 230, 240, and 250 may comprise any of the sensors described herein. Non-limiting examples of sensors include electrocardiogram (EKG/ECG) sensors, temperature sensors, blood glucose sensors, pressure sensors, accelerometers, gyroscopes, acoustic sensors (ultrasonic or microphone), respiration sensors, cameras, thermal imaging, blood pressure sensors, optical sensors, heart rate sensors, respiratory rate, oxygenation sensors, oxygen saturation sensors, and pulse oximetry (Sp02) sensors. Such sensors may comprise transmitters, receivers, sources, detectors, probes, electrodes, dome contacts, transducers, MEMs devices, implanted devices, etc. Sensing can be conducted by the sensors directly or indirectly (i.e., inferred). In one embodiment, sensors 230, 240, and 250 may further include an implanted device (such as a pacemaker, temperature, or glucose sensor) that can be powered and/or queried wirelessly by a transceiver such as sensors 230, 240, and 250. Sensors 230, 240, and 250 are configured to communicate the data/information obtained (sensed) to the monitor unit 210.

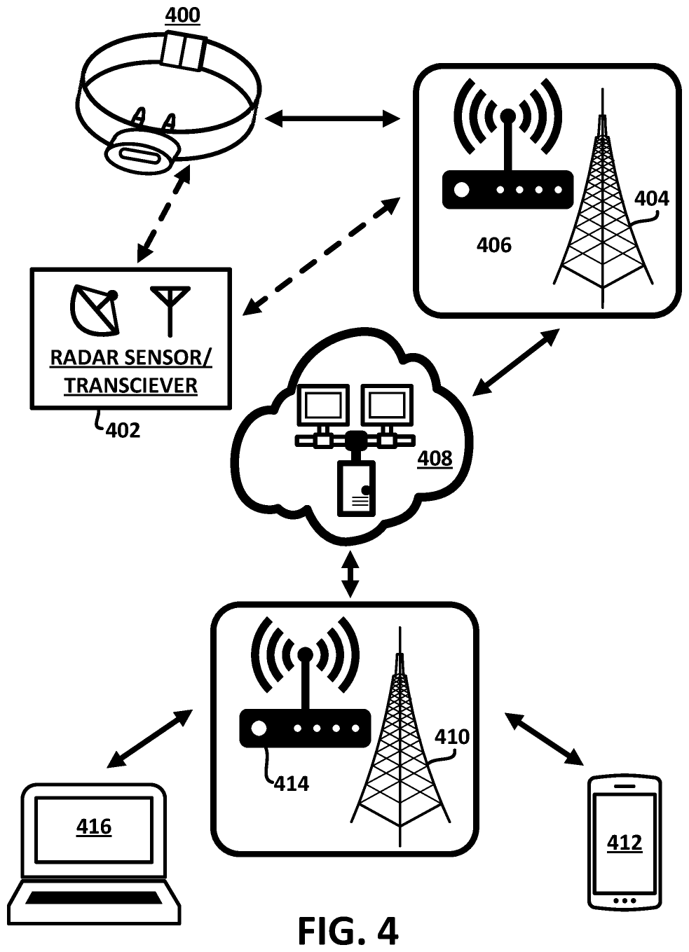

Wireless communication modules 224 provide connectivity between monitor unit 210 and external devices or systems. Example devices or systems that monitor unit 210 is configured communicate with include: cellular towers and networks, Wi-Fi devices, routers and other wireless networks and systems, Bluetooth devices and systems, cameras, microphones, external sensors, PCs and laptops, smart phones and tablets, and a radar-based sensor system (described in more detail in FIG. 4).

I/O modules 226 are configured to enable a user to input and receive information, data, or instructions to/from monitor unit 210. I/O modules 226 can include a user interface and display, such as user interface 108 and display 106 described in FIG. 1. Via I/O modules 226, a user may input information about the animal being monitored, set configurations for the monitoring, change settings of the monitor unit 210, gather information from the memory, and update software running on monitor unit 226. Users may also access I/O modules 226 using external devices connected via wireless communication modules 224 to input information about the animal being monitored, set configurations for the monitoring, change settings of the monitor unit 210, gather information from the memory, and update software running on monitor unit 226.

GPS Module 228 may comprise a module configured to receive information/data transmitted by GPS satellites. GPS module 228 may contain an antenna and processor capable of determining the monitor unit's position and time from signals received from satellite navigation systems.

Power source 230 is configured to provide power to various elements of monitor unit and may comprise a rechargeable or replaceable battery. Power source 230 may further comprise power management processors and charging ICs configured to optimize the charging and distribution of the power source 230 across various components. Power source 230 may further be configured to provide power to various sensors connected to monitor unit 210. Power source 230 may be charge wirelessly or via electrical contacts of monitoring system 200.

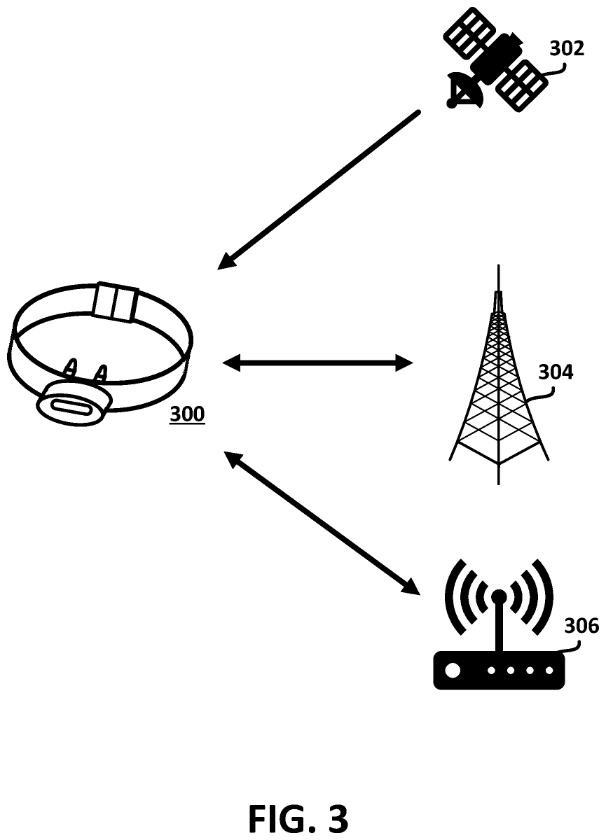

FIG. 3 illustrates a monitoring system 300. Monitoring system 300 can be configured to detect transmissions from satellite navigation systems 302 in order to determine time and location of monitoring system 300. Monitoring system 300 can be configured to transmit and/or receive data to/from cellular networks such as wireless or cellular network 304. Monitoring system 300 may also be configured to transmit and/or receive data to/from wireless networks of devices such as wireless network 306. Nonlimiting examples of wireless networks 304 and 306 include cell phone networks, wireless local area network(s), wireless sensor network(s), WiFi networks, and Bluetooth networks. Such networks may be further configured to be connected to internet servers, websites, applications, and/or cloud storage systems. Such networks may also comprise local systems such as PCs, laptops, cell phones, tablets, smart devices, etc.

In one example, monitoring system 300 is a light weight, multiparameter animal monitoring system that can be accessed via an application (“app”) installed on a client device (e.g. a cell phone or laptop). For example, the client device and associated app may communicate directly with the monitoring system 300 via a Bluetooth network connection 306 wherein Bluetooth network transceivers are located within the client device and monitoring system 300. According to several examples, monitoring system 300 may be configured to transmit health and activity information upon request, at scheduled or predetermined intervals, or substantially continuously.

FIG. 4 illustrates a monitoring system 400 configured to operate in connection with a radar-based system or sensor 402. Radar-based system 402 is configured to conduct radar-based remote physiological sensing of the animal being monitored. Radar-based system 402 can be configured to utilize microwave doppler radar-based transmitter-receiver as a contactless, unobtrusive sensors of health and activity information, such as respiratory, heart rate, tidal volume, and/or heart rate variability monitoring of the animal.

In one example, radar-based system 402 employs 24 Ghz contactless technology, including a radar sensor using frequency modulated continuous wave technology (hereinafter “FMCW”). Combining FMCW radar sensing with predictive AI machine learning can enable effective, contactless sensing over a wide variety of animal types, sizes, hair, color, epidermal and dermal thickness and pigmentation.

Radar-based system 402 may further include a camera for use in distinguishing the animal from various other entities within the field of radar-based system 402. The camera may also be used to provide a live video feed of the animal to a user of the monitoring system via an internet server. Radar-based system 402 may also be configured to measure radar-cross section of the animal. Such information can be used to determine the shape, orientation, posture, emotion, activity, and position of the animal. Radar-based system 402 can be configured to communicate wirelessly with, or in conjunction with, monitoring system 400. Monitoring system 400 can transmit health and activity information and data (hereinafter “HAID”) to an internet server 408 via wireless networks such as wireless networks 406 and 404. Remote servers 408 can host, analyze, and transmit HAID to remote users and devices such as devices 416 and 412 via wireless networks 414 and/or 410. Alternatively, monitoring system 400 may also transmit HAID directly to nearby users and devices as described in various embodiments of FIG. 3.

According to one example, a user may desire to monitor the HAID of an animal remotely. The user may use a device, such as a cell phone 412, to access a website hosted on a server 408 via a wireless network such as a cellular network 410. The use can enter credentials into the website to securely access information specific to the individual animal. In response to an authenticated request, the server may transmit HAID to the user device 412 via the cellular network 410. The server 408 obtains, stores, and analyzes HAID from monitoring system 400, and/or radar-based system 402 via wireless networks such as a internet-connected Wi-Fi network 406.

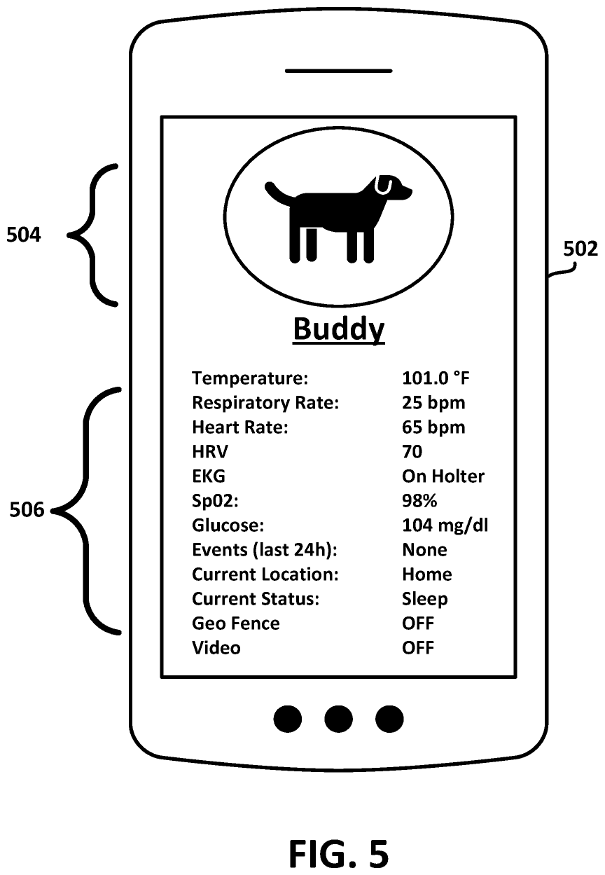

FIG. 5 illustrates an example monitoring application or website used by a user to access the HAID of an animal. According to FIG. 5, a device, such as a cell phone 502 may access a server/website to receive HAID about an animal. The HAID provided may include information such a name, picture, or video 504 of the animal and may further include HAID 506 such as temperature, Respiratory Rate, Heart Rate, Heart Rate Variability, EKG, Sp02, Glucose, Location, Status, Health Alerts, Location Alerts, Activity Alerts, etc. The application/website may also be configured to provide a live video feed of the animal from the camera described in FIG. 4. The application or website can also be used to transmit information and control signals back to the monitoring system. For example, a user may turn on or off a geofence at the monitoring system by using the website/application. A user may also review historical data stored on a server via the website/application. The user may also configure the app to transmit alerts or notifications when certain events or information is detected by the monitoring system. For example, the website/application may transmit a notification to the user when the animal is barking, or when the animal wakes up, or when the animal's temperature exceeds a preset value.

While the subject matter of the invention is described with specific and example embodiments, the foregoing drawings and descriptions thereof depict only typical embodiments of the subject matter and are not therefore to be considered limiting of its scope. It is evident that many alternatives and variations will be apparent to those skilled in the art and that those alternatives and variations are intended to be included within the scope of the present invention. For example, some embodiments described herein include some elements or features but not other elements or features included in other embodiments, thus, combinations of features or elements of different embodiments are meant to be within the scope of the invention and are meant to form different embodiments as would be understood by those skilled in the art.

As the claims hereinafter reflect, inventive aspects may lie in less than all features of a single foregoing disclosed embodiment. Thus, the hereinafter expressed claims are hereby expressly incorporated into this Detailed Description, with each claim standing on its own as a separate embodiment of the invention.

1. An animal monitoring system comprising:
a collar;
a monitor unit coupled to the collar;
a first sensor and a second sensor coupled to the collar, wherein the first sensor is configured to obtain a first datum associated with a first health and activity characteristic and the second sensor is configured to obtain a second datum associated with a second health and activity characteristic;
a radar-based sensor configured to obtain a third datum associated with a third health and activity characteristic;
wherein the animal monitoring system is configured to transmit the first datum, the second datum, and the third datum to an external system via a wireless network.

2. The animal monitoring system of claim 1, wherein the external system is a client device.

3. The animal monitoring system of claim 2, wherein the client device is a cell phone.

4. The animal monitoring system of claim 1, wherein the external system is a server.

5. The animal monitoring system of claim 1, wherein the first health and activity characteristic comprises one of an animal's heart rate, an animal's respiratory rate, an animal's activity level, an animal's temperature, an animal's blood oxygen level, an animal's electrocardiogram, an animal's blood glucose level, an animal's step count, an animal's caloric expenditure, an animal's sleep pattern, and an animal's location.

6. The animal monitoring system of claim 5, wherein the second health and activity characteristic comprises one of an animal's heart rate, an animal's respiratory rate, an animal's activity level, an animal's temperature, an animal's blood oxygen level, an animal's electrocardiogram, an animal's blood glucose level, an animal's step count, an animal's caloric expenditure, an animal's sleep pattern, and an animal's location.

7. The animal monitoring system of claim 6, wherein the third health and activity characteristic comprises one of an animal's radar-cross section, an animal's shape, an animal's orientation, an animal's posture, an animal's emotion, an animal's activity, an animal's position, an animal's heart rate, an animal's respiratory rate, an animal's activity level, an animal's temperature, an animal's blood oxygen level, an animal's electrocardiogram, an animal's blood glucose level, an animal's step count, an animal's caloric expenditure, an animal's sleep pattern, and an animal's location.

8. The animal monitoring system of claim 1, wherein the first sensor comprises an RFID reader.

9. The animal monitoring system of claim 1, further comprising a Bluetooth communication module.

10. The animal monitoring system of claim 1, further comprising an implantable temperature sensor configured to be read by the first sensor.

11. An animal monitoring system comprising:
a collar;
a monitor unit coupled to the collar;
a first sensor and a second sensor coupled to the collar, wherein the first sensor is configured to obtain a plurality of first data associated with a first health and activity characteristic and the second sensor is configured to obtain a plurality of second data associated with a second health and activity characteristic;
a radar-based sensor configured to obtain a plurality of third data associated with a third health and activity characteristic;
a controller configured to the process the plurality of first data and generate a first alert associated with the first health and activity characteristic, and wherein the controller is configured to the process the plurality of second data and generate a second alert associated with the second health and activity characteristic, and wherein the controller is configured to process the plurality of third data and generate a third alert associated with the third health and activity characteristic;
wherein the animal monitoring system is configured to transmit at least one of the first alert, the second alert, and the third alert to an external system via a wireless network.

12. The animal monitoring system of claim 11, wherein the external system is a client device.

13. The animal monitoring system of claim 12, wherein the client device is a cell phone.

14. The animal monitoring system of claim 11, wherein the external system is a server.

15. The animal monitoring system of claim 11, wherein the first health and activity characteristic comprises one of an animal's heart rate, an animal's respiratory rate, an animal's activity level, an animal's temperature, an animal's blood oxygen level, an animal's electrocardiogram, an animal's blood glucose level, an animal's step count, an animal's caloric expenditure, an animal's sleep pattern, and an animal's location.

16. The animal monitoring system of claim 15, wherein the second health and activity characteristic comprises one of an animal's heart rate, an animal's respiratory rate, an animal's activity level, an animal's temperature, an animal's blood oxygen level, an animal's electrocardiogram, an animal's blood glucose level, an animal's step count, an animal's caloric expenditure, an animal's sleep pattern, and an animal's location.

17. The animal monitoring system of claim 16, wherein the third health and activity characteristic comprises one of an animal's radar-cross section, an animal's shape, an animal's orientation, an animal's posture, an animal's emotion, an animal's activity, an animal's position, an animal's heart rate, an animal's respiratory rate, an animal's activity level, an animal's temperature, an animal's blood oxygen level, an animal's electrocardiogram, an animal's blood glucose level, an animal's step count, an animal's caloric expenditure, an animal's sleep pattern, and an animal's location.

18. The animal monitoring system of claim 11, wherein the first sensor comprises an RFID reader.

19. The animal monitoring system of claim 11, further comprising a Bluetooth communication module.

20. The animal monitoring system of claim 11, further comprising an implantable temperature sensor configured to be read by the first sensor.
